(19) United States
(12) Patent Application Publication
(10) Pub. No.: US 2023/0014832 A1
(43) Pub. Date: Jan. 19, 2023

(54) METHOD OF AND SYSTEM FOR MANAGING A REWARD PROGRAM

(71) Applicant: GREAT CONTINENT HOLDINGS INTERNATIONAL LIMITED, Dubai (AE)

(72) Inventor: James Dey, Dubai (AE)

(73) Assignee: GREAT CONTINENT HOLDINGS INTERNATIONAL LIMITED, Dubai (AE)

(21) Appl. No.: 17/949,555

(22) Filed: Sep. 21, 2022

Related U.S. Application Data
(63) Continuation of application No. 17/012,321, filed on Sep. 4, 2020, now abandoned.

(51) Int. Cl. G06Q 30/02

(52) U.S. Cl. CPC G06Q 30/0217; G06Q 30/0239; G06Q 30/0232

(57) ABSTRACT

A computer network based rewards program, management method, and system in which rewardable promotions of predetermined goods or services by enrolled promoter entities on network platforms are automatically recognized and rewarded in accordance with criteria established by rewarder entities. Content analysis engines employed by the system may invoke machine learning tools. Contexts of the promotions may be analyzed and characterized for compliance with the criteria.

### RELATED APPLICATION DATA

This application is a continuation under 35 U.S.C. Sec. 120 of U.S. patent application Ser. No. 17/012,321 filed Sep. 4, 2020, the contents of which are incorporated by reference in their entirety. All benefits of the filing date of application Ser. No. 17/012,321 are claimed.

### FIELD OF THE INVENTION

The present invention relates to reward programs and methods of and systems for managing them.

### BACKGROUND OF THE INVENTION

Reward programs, as such, are well known. In general, reward programs are structured marketing strategies designed by companies to encourage customers to purchase or continue to purchase goods and/or services, either at a physical shop outlet or through any other channel, such as online etc. These programs exist covering most types of commerce, each one having varying features and rewards schemes. In marketing generally and in retailing more specifically, a loyalty card, rewards card, points card, club card etc. is a plastic or paper card, visually similar to a credit card, debit card, or digital card that identifies the card holder as a participant in a reward program. There also are digital based online and mobile device reward programs, typically using mobile telephone numbers and/or email addresses, but the basic, underlying reward programs are similar to the traditional systems. Reward programs may also be known as “Loyalty Programs” or “Loyalty Schemes”.

Social Media Influencer marketing programs are also well known. In general, these programs involve an entity with a brand, agreeing to pay a fee to an individual who has a relevant social media following on one or more social media or content distribution platforms including, but not limited to, Instagram, Tiktok, Snapchat, Facebook, Youtube and Twitter. In certain cases, marketplace platforms such as tapfluence (www.tapinfluence.com), awario (https://awario.com), and klear (https://klear.com) which are directed to the influencer market to allow searches and analysis of databases of these influencers to ascertain many aspects of their profiles and followings. In other cases, the entity might establish contact with the individual directly via the social media or content platform, or via a third party representative such as a management agent. The entity then negotiates a fee with the influencer, to include, one or several times, the entity's product or service either as a mention in the text related to their post, in an image, a video or an audio post or upload.

### SUMMARY

The present application describes embodiments of one or more inventions relating to systems for and methods of managing computer network based reward programs. Such a system may also be referred to herein as a “reward program management system.” A “system” can be considered an apparatus.

The computer network can be any suitable digital telecommunications network for sharing resources between nodes, which computing devices use a common telecommunications technology, and where data transmission between nodes is supported over data links consisting of physical cable media, such as twisted pair or fiber-optic cables, or by wireless methods, such as Wi-Fi, cellular communication services, microwave transmission, or free-space optical communication. The computer network can be private or public.

In an embodiment, the computer network is the Internet.

In an embodiment, a computer network based reward program rewarder entity rewards online promotion of a good, a service, or both by a promoter entity. As used herein, a rewarder entity is a person or juridical entity that agrees to provide or provides a reward to a promoter entity for rewardable promotion of a good or service via the system for managing a reward program. As used herein, a promoter entity is a person or juridical entity enrolled in the reward program to be rewarded for promoting a good or service.

As used herein, the phrase “promotion of a good or service” generically encompasses inclusion of, mention of, placement of, presentation of, depiction of, or reference to a brand, good, service, or any combination of them, i.e., the inclusion of an item to which a value might be attributed. The phrase “promoting a good or service” generically encompasses including, mentioning, placing, presenting, depicting or referencing a brand, good, service or any combination of them, i.e., including an item to which a value might be attributed. Also, “promote” and “promotion” encompass inclusion, mention, placement, presentment, depiction, or reference to a brand, good, service, or any combination of them, again, i.e., the inclusion of an item to which a valued might be attributed. The promotion of a good or service can be effectuated by a posting on an online platform on the computer network.

As used herein, “automatically” and “automatic” mean without intervention, especially human intervention.

In an embodiment, a system for managing a reward program includes a system for enrolling a promoter entity into a reward program, identifying promotion of a preselected good or service by the promoter entity, and rewarding the promoter entity for such promotion of the good or service.

A “reward” includes kudos, acknowledgments, memberships (e.g., in a club), credits, real money, virtual money, goods, services, to name a few.

In an embodiment, a system for managing a reward program associates, over a preselected time period, a promoter entity with (a) posting of media that includes the presence of a preselected good or service by the promoter entity, and (b) rewards attributed to the presence of the preselected item in the post, based on preselected criteria.

In an embodiment, a system for managing a reward program contextualizes each promotion and associates a qualitative judgement with the promotion.

In an embodiment, the contextualization of the promotion includes an assessment of positive and negative aspects of a context in which the promotion is effectuated.

In an embodiment, the contextualization of the promotion includes an assessment of an amount of or degree to which the promotion is cited or approved by others.

In an embodiment, a system for managing a reward program includes a system for enrolling one or more promoter entities that enrolls the one more promoter entities by associating each promoter entity with one more online platform accounts via which the promoter entity's inclusion of preselected goods or services in posts is to be tracked. An online platform can be a website, mobile phone, computer, or similar applications on which a user such a promoter entity can post content. The promoter entities can have accounts which can be public and available for consumption (e.g., reading, viewing, listening) of the content by any computing device that can navigate to the account via the network, or private with restricted access to computing devices which present (input) acceptable credentials (e.g., login information) or which meet account access criteria set by the platform and/or the promoter entity. For some websites it can be sufficient that a promoter entity has access to post information on the website, preferably in a way that it can be confirmed that the posting was made by the promoter entity.

Accordingly, a promoter entity will either authenticate on the platform using their own login information, or give the reward program management system permission to follow or access the promoter entity by “following” their account on the platform. In cases where a promoter entity has a private account, the promoter entity may need to give the reward program management system permission to follow them. Also, the reward program management system may need to have its own account on the platform (or each platform), and the reward program management system would operate through this account (or these accounts). As an example, “@cokeloyalty” could be the Instagram™ account associated with a Coca Cola Company reward program, used by the reward program management system.

In an embodiment, a system for managing a reward program receives one or more feeds from online platform accounts associated with a promoter entity.

In an embodiment, a system for managing a reward program includes a content analysis engine that can search online platforms and identify a the presence of a good or service in media posts.

A “content analysis engine” means any computing device application that can analyze a posting on a platform and recognize a promotion. Such recognition may include a contextual analysis. Such an application may employ artificial intelligence, generally, or a machine learning tool, specifically. Other technologies may be employed such as correlation algorithms that cross-correlate goods or servie in posting with stored lists of goods or services.

In an embodiment, a system for managing a reward program includes a content analysis engine that can analyze images, videos, sounds, text, or any combination of the foregoing, and recognize each unique promotion of a good or service.

In an embodiment, a system for managing a reward program includes a content analysis engine which can search posts of one or more promoter entities on Internet-based social media or content sharing platforms and identify the presence of an item with the intention of attributing value to it.

As used herein, “social media” encompasses interactive computer-mediated technologies that facilitate the creation or sharing of information via virtual communities and networks, as well mobile applications, electronic bulletin boards, blogs, peer to peer file sharing systems, video sharing sites and applications, esports and gaming platforms and electronic magazines.

In an embodiment, a method of managing a reward program, comprises:

automatically accessing content posted by a promoter entity on a platform of a computer based network by means of a computing device;

automatically invoking a digital content analysis engine to analyze the content to identify promotion of a preselected good or service by means of the computing device; and

automatically attributing a value to the promoter entity if rewardable promotion of the preselected good or service is recognized by means of the computing device.

In an embodiment, a method of managing a reward program is performed autonomously and automatically by means of the computing device.

In an embodiment, the digital content analysis engine employs a technology such as artificial intelligence to recognize the good or service and/or context of the promotion.

In an embodiment, a method of managing a reward program comprises:

automatically accessing one or more postings of a promoter entity on an online platform by means of a computing device;

automatically using a digital visual content analysis engine to identify preselected goods or services appearing in the one or more postings by means of the computing device; and

automatically rewarding the promoter entity in accordance with terms of the reward program for each rewardable promotion of the preselected good or service in the one or more postings by means of the computing device.

In an embodiment, the rewards can take the form of points, credits, real money, or virtual money.

In an embodiment, the amount of the credits or money can be based on the number of unique instances in which the promoter entity promotes the good or service, contexts in which the good or service is promoted, a number times the promotion is recognized by others, the number of “likes” the promotion receives and/or positive comments by others as to the good or service.

In an embodiment, the digital content analysis engine can recognize the promoter entity in a posting using recognition algorithms or by tagging applied to the promotion of the good or service.

In an embodiment, the method includes the step of detecting a symbol, such as a hashtag, in the social media post, associated with the product.

In an embodiment, there is provided a system for managing a computer network based reward program, the system comprising:

at least one processor; and

a memory coupled to the processor, the memory containing instructions which when executed cause the at least one processor to:
automatically access postings of a promoter entity on an online platform;
automatically invoke a content analysis engine to identify a good or service shown in the postings; and
automatically credit the promoter entity in accordance with terms of the reward program when promotion of the good or service enrolled in the reward program for rewarding.

In an embodiment, the credits take the form of rewards and/or credits and/or points and/or cash payments, usually with reference to an account of the promoter entity.

In an embodiment, the credits are converted to or redeemed in cash.

In an embodiment, a visual content analysis engine is used to determine the number of times that a preselected good or service appears in a photograph, image, or video.

In an embodiment, the disclosure provides a non-transitory storage medium having computer processor executable instructions that when executed by one or more computer processors, cause the one or more computer processors to:

enroll a promoter entity in a reward program by associating the promoter entity with one or more computer network-based platform accounts;

automatically search the one or more platform accounts for promotion of a preselected good or service;

automatically recognize a rewardable promotion of the preselected good or service by the promoter entity on a network platform;

automatically award the promoter entity a predetermined reward for the rewardable promotion of the preselected good or service.

In an embodiment, automatically recognizing a rewardable promotion includes comparing characterization data of the promotion against predetermined criteria establishing parameters for when a promotion can be deemed rewardable.

In an embodiment, the reward includes an item of value selected from the group consisting of an acknowledgement, a membership, a credit, real money, virtual money, a blockchain token, a good, and a service or simply an acknowledgement that the promoter has elected to be part of a program or community.

In an embodiment, the instructions, when executed by one or more computer processors, cause the one or more computer processors to:

recognize a context in which the promotion of the good or service is made; and

associate a qualitative judgment with the promotion of the good or service.

In an embodiment, the instructions, when executed by one or more computer processors, cause the one or more computer processors to:

recognize a context in which the promotion of the good or service is made; and

associate a quantitative assessment with the promotion of the good or service.

In an embodiment, automatically recognizing a rewardable promotion of the preselected good or service by the promoter entity comprising automatically invoking a content analysis engine.

In an embodiment, the content analysis engine automatically invokes a machine learning tool.

In an embodiment, the network platform is a social medium or content sharing platform.

In an embodiment, the instructions, when executed by one or more computer processors, cause the one or more computer processors to enroll a rewarder entity by receiving rewarder entity data that associates a rewarder entity with the preselected good or service and the criteria.

In an embodiment, the disclosure provides a system comprising:

one or more data processors connected to a computer network;

computer processor readable memory in communication with the one or more processors; and

stored in the memory, code including data processor executable instructions, the code including:
a promoter entity enrolment module which can (a) receive promoter entity data identifying the promoter entity and (b) associate the promoter entity one or more platforms on the computer network;
a rewarder entity enrolment module which can receive rewarder entity data identifying the rewarder entity, a good or service, and reward program information with criteria for rewarding promotion of the good or service;
a content analysis engine which can search a posting on the one or more platforms and generate a search result;
a promotions tracking module which automatically invokes the content analysis engine and analyze the search result to identify a rewardable promotion; and
one or more databases storing the promoter entity data and the rewarder entity data.

In an embodiment, the code includes a rewards tracking module via which the rewarder entity can review the each promotion by the promoter entity.

In an embodiment, the code includes a machine learning tool automatically invocated by the content analysis engine.

In an embodiment, the machine learning tool is effective to generate a qualitative characterization of a context in which the promotion is recognized.

In an embodiment, the machine learning tool is effective to generate a quantitative characterization of a context in which the promotion is recognized.

In an embodiment, the platforms are social media, gaming and, photo sharing and video sharing platforms.

In an embodiment, the code further comprises a promoter entity interface via which the promotor entity can enroll in the reward program system.

In an embodiment, the code further comprises a rewarder entity interface via which the rewarder entity can enroll in the reward program system.

In an embodiment, the code establishes automatic invocation of the content analysis engine by the promotions tracking module.

In an embodiment, the disclosure provides a method of managing reward program comprising executing processor executable computer instructions on a server connected to a computer network and:

enrolling a promoter entity in a reward program system by associating the promoter entity with one or more computer network-based platform accounts and a predetermined good or service;

automatically invoking a content analysis engine and searching posts on the one or more platform accounts for promotions of the preselected good or service;

automatically recognizing a rewardable promotion of the preselected good or service by the promoter entity; and

automatically rewarding the promoter entity with a predetermined reward for the rewardable promotion of the preselected good or service.

In an embodiment, the searching includes using a machine learning tool to identify the preselected good or service in the promotion.

In an embodiment, the recognizing includes identifying and storing data characterizing the promotion.

In an embodiment, the rewarding includes allocating the reward in accordance with predetermined criteria and data characterizing the recognized promotion.

In an embodiment, the method further comprises enrolling a rewarder entity by associating the rewarder entity with the preselected good or service and criteria for awarding the loyalty reward.

In an embodiment, the enrolling of the promoter entity comprises serving a promoter entity enrolment interface with interactive webpages or an interactive computing device application via which the promoter entity can enter promoter entity data including the one or more computer network-based platform accounts.

In an embodiment, the enrolling of a rewarder entity comprises serving a rewarder entity enrolment interface with interactive webpages or a computing device application via which the rewarder entity can enter rewarder entity data identifying the rewarder entity and the preselected good or service and the criteria for awarding the loyalty reward.

In an embodiment, the network-based platforms are social media, gaming or, photo, audio, or text sharing, podcast, or video sharing platforms.

In an embodiment, the method further comprises using the machine learning tool to provide a qualitative characterization of a context in which the good or service is promoted.

These and other aspects of the various embodiments and features disclosed herein are discussed below in greater detail with reference to the accompanying drawings.

### BRIEF DESCRIPTION OF THE DRAWINGS

Embodiments of the invention will be described, by way of example only, with reference to the accompanying drawings in which:

FIG. 1 illustrates a schematic of a computer network system in which principles disclosed herein can be applied.

FIG. 2 illustrates a schematic of a computing server that can be used to implement principles disclosed herein.

FIG. 3 illustrates a schematic of interactions between various entities in accordance with principles disclosed herein.

FIG. 4 depicts major components of a computer based reward program management system.

FIG. 5 depicts a relational database associated with a promoter entity.

FIG. 6 depicts a relational database associated with a rewarder entity.

FIG. 7 depicts a flow chart of a method for developing a machine learning tool for a content analysis engine.

FIG. 8 depicts a system for developing a machine learning tool for a content analysis engine.

FIG. 9 depicts a flow chart of a method for rewarding a promoter entity.

FIG. 10 depicts a flow chart of another method for rewarding a promoter entity.

### DETAILED DESCRIPTION

The following description is provided as an enabling teaching of various embodiments. Those of ordinary skill in the relevant art will recognize that many changes can be made to the embodiments described, while still attaining the beneficial results of the principles disclosed herein. It will also be apparent that some of the desired benefits of the principles disclosed herein can be attained by selecting some of the features of the present invention without utilizing other features. Accordingly, those of ordinary skill in the art will recognize that modifications and adaptations to the embodiments are possible and can even be desirable in certain circumstances. Thus, the following description is provided as illustrative of the principles of the present invention(s) and not a limitation thereof

Promotion Program Management System

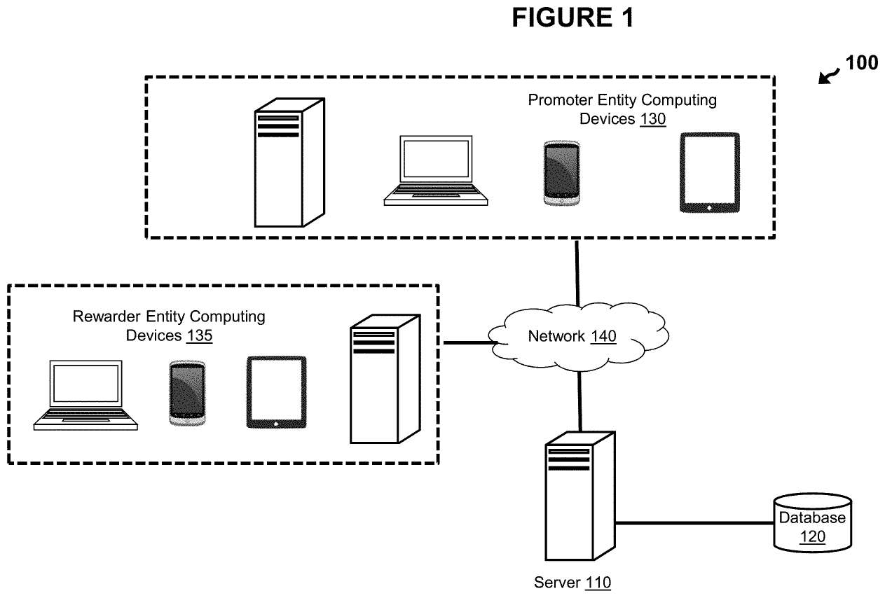

FIG. 1 illustrates components of a system 100 for managing a computer network based reward program, according to an embodiment. The system 100 may comprise a computer server 110, a database 120, and a set of client computing devices 130 and 135 that connected to one or more networks 140 via hardware and software components of the network(s). The client computing devices 130 are representative of promoter entities while the client computing devices 135 are representative of rewarder entities. Examples of the network 140 include, but are not limited to, Local Area Network (LAN), Wireless Local Area Network (WLAN), Metropolitan Area Network (MAN), Wide Area Network (WAN), and the Internet. The communication over the network 140 may be performed in accordance with various communication protocols, such as Transmission Control Protocol and Internet Protocol (TCP/IP), User Datagram Protocol (UDP), and IEEE communication protocols.

The server 110 may be any computing device comprising a processor and other computing hardware and software components. The server 110 may be logically and physically organized within the same or different devices or structures, and may be distributed across any number of physical structures and locations (e.g., cabinets, rooms, buildings, cities).

The server 110 is a computing device comprising a processing unit. The processing unit may include a processor with computer-readable medium, such as a random access memory coupled to the processor. To that end, the server 110 may be running algorithms or computer executable program instructions, which may be executed by a single processor or multiple processors in a distributed configuration. The server 110 may be configured to interact with one or more software modules of a same or a different type operating within the system 100.

Non-limiting examples of a processor may include a microprocessor, an application specific integrated circuit, and a field programmable object array, among others. Non-limiting examples of the server 110 may include a server computer, a workstation computer, a tablet device, and a mobile device (e.g., smartphone). Some embodiments may include multiple computing devices functioning as the server 110. Some other embodiments may include a single computing device capable of performing the various tasks described herein.

The sets of client computing devices 130 and 135 may be any computing device allowing a user to interact with the server 110. The client computing devices 130 and 135 may be any computing device comprising a processor and non-transitory machine-readable storage medium. The examples of the computing device may include, but are not limited to, a desktop computer, a laptop, a personal digital assistant (PDA), a smartphone, a tablet computer, and the like. The client computing devices 130 may comprise any number of input and output devices supporting various types of data, such as text, image, audio, video, and the like.

The server 110 may receive promoter entity information via a mobile application (e.g., client application) installed in a client computing device 130 and/or a web application (e.g., comprising a hyperlink of a website). The server 110 may display a graphical user interface (GUI) on the client computing device 130 that allows the promoter entity to input user information, such as the promoter entity's basic information including, e.g., name, age, gender, location (e.g., home address), zip code, email address, and the like. The promoter information may also identify one or more platforms on which the promoter entity would like to be tracked on behalf of a rewarder entity.

In some embodiments, the server 110 may collect promoter entity information from external sources (not shown). The server 110 may web crawl various websites (e.g., social networks) and collect the promoter entity's relevant data from the various websites. In some other embodiments, the server 110 may receive one or more documents containing the user information from a client computing device 130 or a client computing device 135. For example, the server 110 may render a GUI on a client computing device 130 or 135 that allows an entity to upload the data.

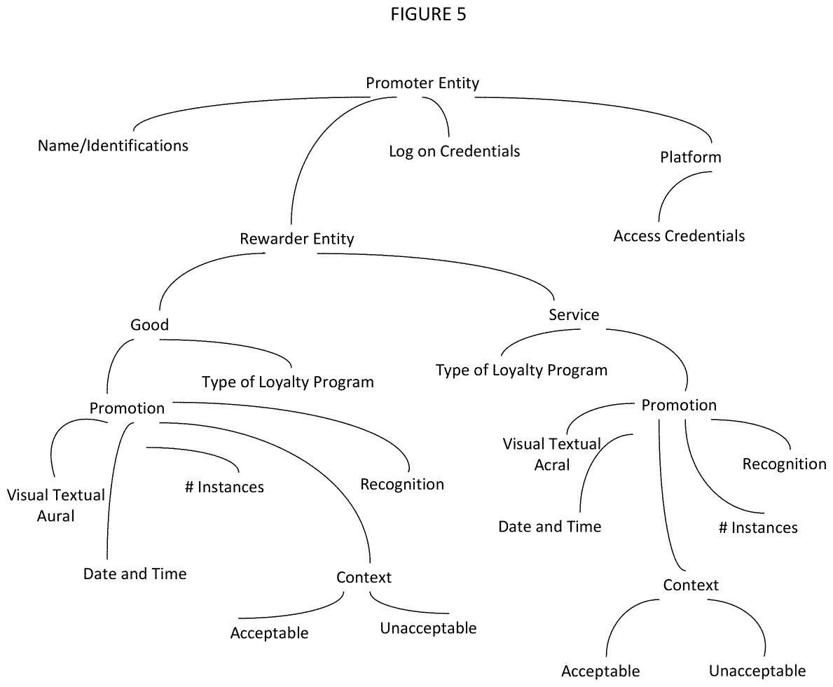

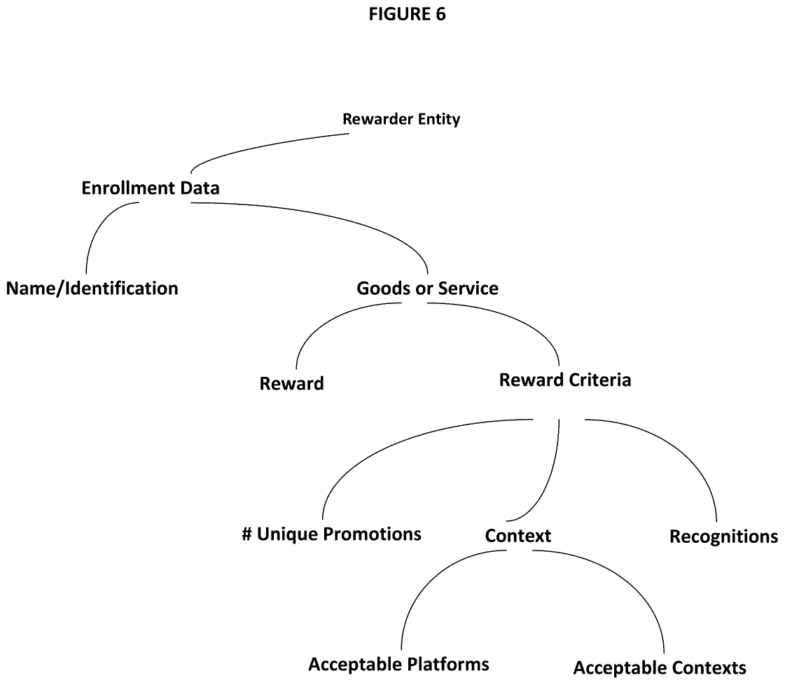

The database 120 represents storage of one more databases with information relating to the promoter entities, rewarder entities, goods or services involved, and reward criteria. The types of data can vary. FIGS. 5 and 6, discussed below depict, relational databases show how some data may be related to other data in such databases.

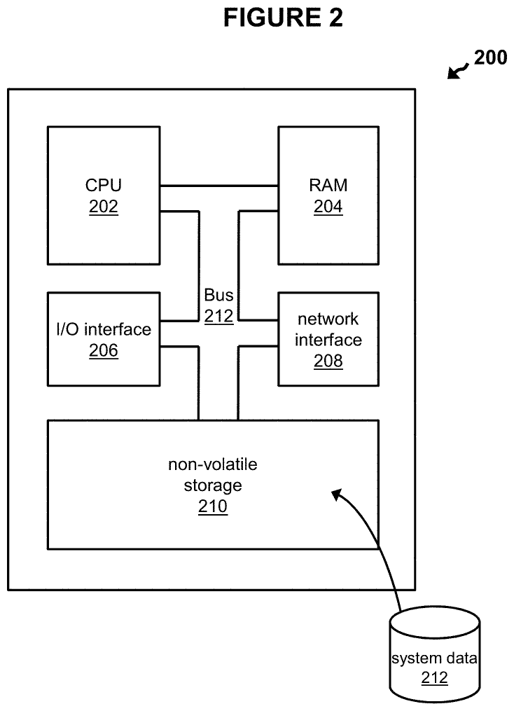

FIG. 2 depicts a server 200 suitable for use in managing a reward program. The server 200 includes a central processing unit (CPU) 202 which can be comprised of one or more data processor, as described above. The server 200 also includes non-transitory volatile computer/data processor readable random access memory (RAM) 204, an input/output interface 206, a network interface 208, and non-transitory non-volatile computer/data processor readable storage 210, all of which are in communication with each other via a bus or bus system 212. System data storage 214 is also in communication with the server 200 via a suitable communication system such as directly via a physical or wireless port of the server 200, or indirectly via the network 140 and the network interface 208.

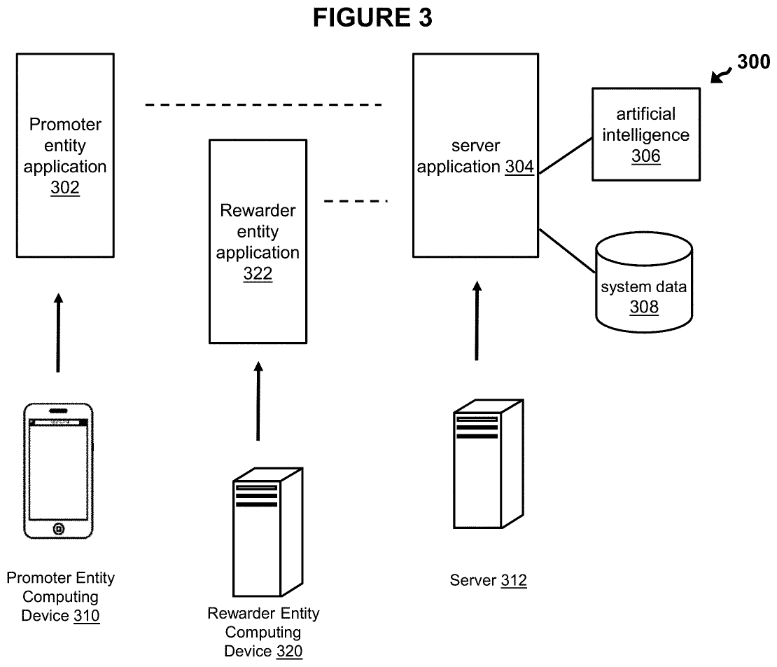

FIG. 3 depicts how a server 312 (such as the server 110 or 200), via which the reward program(s) is/are managed and hosted, a promoter entity 210 and a rewarder entity 320 interact. As illustrated, a promoter entity may interact with the server 312 via an application 302 running on the promoter entity's computing device 310 or directly via a server application 304 running on the server 312. Similarly, a rewarder entity may interact with the server 312 via an application 322 running on the rewarder entity's computing device 320, or directly via the server application 304. The server application 304 may employ the system data in the one or more databases 308, the content analysis engine(s) 306, or both to identify rewardable promotions of goods or services by promoter entities and appropriately reward such promotions.

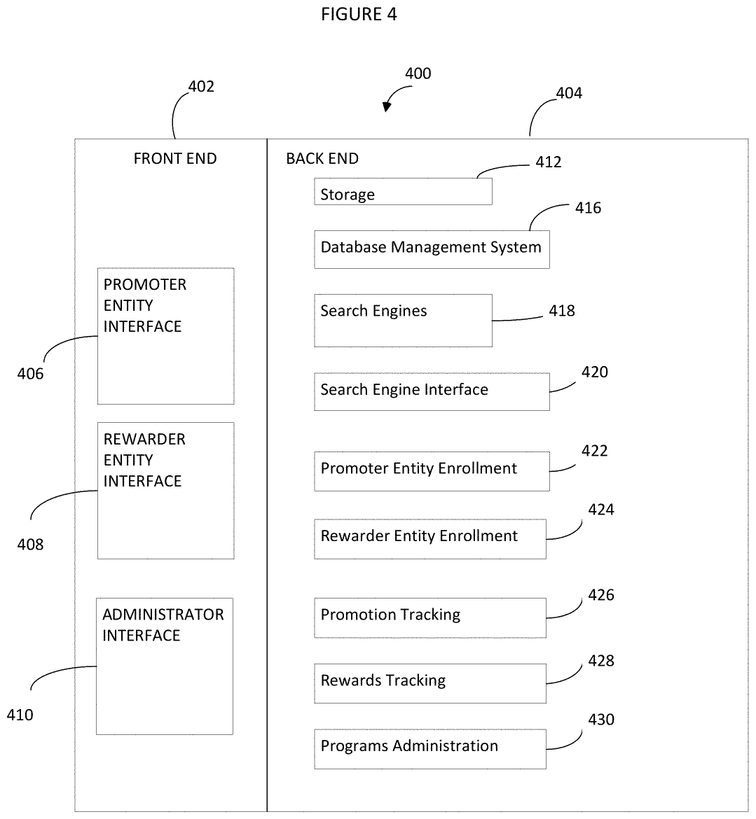

FIG. 4 depicts major components of a reward program management system employing principles disclosed herein. As illustrated, the system 400 may include a front end 402 and a back end 404. The front end may include various interfacing tools whereas the back end may include the various modules and tools invoked by the system during operation. The interfacing tools preferably comprise interactive web pages served up by the server.

Preferably, the front end 402 includes a promoter entity interface 406 via which a promoter entity may interact with the system. Such interactions include submitting enrolment data and monitoring of the tracking and rewarding of promotions. Preferably a promoter entity interface comprises a first graphical user interface (GUI) comprised of one or more interactive webpages served up by the server. Similarly, a rewarder interface 408 preferably comprises a second graphical user interface comprised of one or more second interactive webpages served up by the server. The rewarder entity may identify goods or services the promotion of which is to be rewarded based on criteria that may be established or submitted by the rewarder entity. An administrator interface 410 preferably comprises a third graphical user interface comprised of one or more third interactive web pages served by the server. The administrator may access and control the operation of the system via such an interface.

The front end 402 may also include a main interface 405, such as a main or home website with a GUI that enables a promoter entity to request access to or interaction with the promoter entity interface. Similarly, the main interface 405 can enable the rewarder entity to request access to or interaction with the rewarder entity interface. While the main interface 405 could enable an administrator to invoke the administrator interface, more typically such access is provided directly, for example, via a separate secure website.

The back end 404 includes storage 412 representative of the database(s) 120, as well as a database management system 416 access to the administrator via the administrator interface 410.

The back end 404 also includes one or more content analysis engines 418 and/or content analysis engine interface(s) 420, the latter being for interfacing with and utilizing the services of external content analysis engines.

The back end 404 also includes various software modules that can be invoked by the interaction of the promoter entities, rewarder entities, and/or administrator. Such modules include a promoter entity enrolment module 422 which gathers promoter entity enrolment data, a rewarder entity enrolment module 424 which gathers rewarder entity enrolment data, a promotions tracking module 426 which automatically invokes the one or more content analysis engines and analyzes the search results to identify rewardable promotions, a rewards tracking module 428 which can be used by rewarder entities to review the promotions within their programs, and a reward program administration module 430 via with the administrator can manage the entire system and make changes to the programs and/or data (e.g. correction of errors).

Databases

FIGS. 5 and 6 depict the relationships between data in at least two databases that can be employed in accordance with principles disclosed herein. FIG. 5 depicts data in a database with information relating to an enrolled promoter entity. FIG. 6 depicts data in a database with information relating to an enrolled rewarder entity.

In FIG. 5, an enrolled promoter entity record 500 can included a number of records or sub-records that can be nested or stored in a relational manner. Other databases may also be suitable in a system disclosed herein, but this one includes some basic information. In FIG. 5, the data are related in a tree that may or may not reflect a hierarchy. In FIG. 5, each record, sub-record, and/or field is representative of one or more record, sub-record, and/or field as should be evident to those of ordinary skill in the art.

As illustrated, a given promotor entity record can include fields for names and/or other identification information such as, e.g., nicknames or handles for platforms or user names. The promoter entity could also have logon credentials to the reward program management system to gain secure access to edit some or all of their enrolment information. Additionally, the promotor entity can list one or more platforms (e.g., social media, gaming and, photo sharing and video sharing sites or other websites) where the promoter entity might post promotions of a good or service. The number of followers of the promoter entity for each platform might also be included or extracted by the reward management system, when accessing the promoter entity's posts.

If access credentials are required by the loyalty management system to access the postings, the database can include a field or fields for those as well. As noted above, a promoter entity will either authenticate on the platform using their own login information, or give the reward program management system permission to follow or access the promoter entity by “following” their account on the platform. In cases where a promoter entity has a private account, the promoter entity may need to give the reward program management system permission to follow them. In such cases, the reward program management system may need to have its own account on the platform, and the reward program management system would operate through this account. As an example, “@cokeloyalty” could be the Instagram™ account associated with a Coca Cola reward program, used by the reward program management system.

In addition to online platforms, the reward program management system can be employed in other instances where user-created content can be accessed. For example, various conferencing systems, Zoom™ being just one example, allow users to generated their own virtual backgrounds. The developers of such systems typically provide application programmer interfaces (APIs) which allow third party applications, such as reward program management system, provided a promoter entity has provided the requisite permissions, to access information of the promoter entity, which can include the virtual backgrounds. The content, can be scrutinized in the same manner as any other content, and if a promoter entity includes rewardable promotions in the content/virtual backgrounds, the promotions can be similarly be rewarded.

As an example, the Zoom App Marketplace is an open platform that allows third-party developers to build applications and integrations upon Zoom's video-first unified communications platform. Zoom™ provides documentation and other information at: https://marketplace.zoom.us/docs/guides. The Zoom API is a means for developers to access a collection of resources from Zoom such as users virtual backgrounds. All APIs under the Zoom API are based on representational state (REST) architecture and are accessed via HTTP at specified universal resource locators (URLs). As explained on Wikipedia (https://en.wikipedia.org/wiki/Representational_state_transfer), REST is a software architectural style that defines a set of constraints to be used for creating Web services. Web services that conform to the REST architectural style, called RESTful Web services, provide interoperability between computer systems on the Internet. RESTful Web services allow the requesting systems to access and manipulate textual representations of Web resources by using a uniform and predefined set of stateless operations.

Zoom has an API at https://marketplace.zoom.us/docs/api-reference/ which webpage provides access to documentation and other information such as how to use the API, in particular at https://marketplace.zoom.us/docs/api-reference/using-zoom-apis. With an API, it becomes possible to gain access to the image or video file selected by the promoter, and to then analyze this file and provide the analysis to the rewards management system.

With the ability to record how many people viewed the wallpaper based on analysing how many people were on the call enables a way to characterize the amount of exposure to a promoter entity's promotion or placement of an item in the conference or the background.

User generated video content platforms such as TikTok™ (https:/www.tiktok.com) and Snapchat™ (https.//www.snapchat.com) being just two examples, allow users to generate short form videos. The developers of such systems typically provide application programmer interfaces which allow third party applications, such as reward program management system, provided a promoter entity has provided the requisite permissions, to access information of the promoter entity, which can include the short videos. The content, can be scrutinized in the same manner as any other content, and if a promoter entity includes rewardable promotions in the videos, the promotions can be similarly be rewarded.

Video sharing and streaming services such as Youtube™ (www.youtube.com) and Vimeo™ (www.vimeo.com) being just two examples, allow users to either upload short or long form videos, or stream live videos and have them available to the public, or to authenticated users. The developers of such systems typically provide application programmer interfaces which allow third party applications, such as reward program management system, provided a promoter entity has provided the requisite permissions, to access information of the promoter entity, which can include the videos posted by the promoter entity. The content, can be scrutinized in the same manner as any other content, and if a promoter entity includes rewardable promotions in the videos, the promotions can be similarly be rewarded. In some cases, no API is needed to view the views and the system can access the videos as if it was a user.

Visual discovery and sharing sites such as Pinterest™ (https://www.pinterest.com and Gentlemint™ (https://gentlemint.com) allow users to post content, generally images that they have generated or found from third party sources. The developers of such systems typically provide application programmer interfaces which allow third party applications, such as reward program management system, provided a promoter entity has provided the requisite permissions, to access information of the promoter entity, which can include images, video and text. The content, can be scrutinized in the same manner as any other content, and if a promoter entity includes rewardable promotions in the posted content, the promotions can be similarly be rewarded.

Video streaming services such as Amazon's Twitch™, Youtube Live™, Vimeo™, Facebook Live™, Instagram TV™, Instagram Live Stories™ being just several examples, allow users to either upload short or long form videos, or stream live videos and have them available to the public, or to authenticated users. The developers of such systems typically provide application programmer interfaces which allow third party applications, such as reward program management system, provided a promoter entity has provided the requisite permissions, to access information of the promoter entity, which can include the videos and audio posted by the promoter entity. The content, can be scrutinized in the same manner as any other content, and if a promoter entity includes rewardable promotions in the videos or audio, the promotions can be similarly be rewarded. In some cases, no API is needed to view the views and the system can view the videos as if it was a user.

Live video and game streaming platforms such as Twitch™ allow users to stream content such as live games, pre-recorded videos and live video broadcasts. The developers of such systems typically provide application programmer interfaces which allow third party applications, such as the reward program management system, provided a promoter entity has provided the requisite permissions, to access information of the promoter entity, which can include the live broadcast while it is running, or a saved version of the live broadcast. The content, can be scrutinized in the same manner as any other content, and if a promoter entity includes rewardable promotions in the video, the promotions can be similarly be rewarded.

As also illustrated, the database can include an identification of one or more rewarder entities whose good(s) and/or service(s) the promoter entity is enrolled to promote. Then associated with the rewarder entity is each good or service of the rewarder entity the promoter entity is enrolled to promote. The associated good(s) and/or service(s) can be all or only some of the goods and services available to promote.

For each good and service, the database can include a record identifying the type of reward program in which the promoter entity is enrolled. The reward program can be the same or different for the goods and/or services. For example, a rewarder entity may have several different reward programs from which the promoter entity chose.

Importantly, each promotion is recorded to together with measurement data such as the data and time of the promotion; the type of promotion: textual, visual, or audible; the number of instances in which a good or service is identified in the promotion; the recognition of the promotion by others; and the context of the promotion, such as whether the context was acceptable or unacceptable. The recognition, as discussed above can take many different forms such as, e.g., positive comments by third parties, re-postings by third parties, and/or social media reaction tags (e.g., Facebook™ “Like” tags, Tiktok™ “likes”, Instagram™ “likes” or reactions, Youtube™ “likes” or comments).

While not expressly included in FIG. 5, the database can also include the data relating to the exposure of the post including, e.g., the number of followers of the promoter entity or the posting. Promoter entities with greater numbers of followers, can provide greater exposure for the good or service, and thus may merit greater rewards. This data may be gathered by the reward management system from the posting or account, or the data might be input into the database by the promoter entity or the reward program administrator. This data can be a subset of the recognition branch, or a separate branch altogether.

FIG. 6 depicts a record 600 for a rewarder entity. As illustrated, the record 600 can include a field with the rewarder entities enrolment data such as name or other identification(s). The enrolment data can also include each good or service the rewarder entity for which the a reward is to be offered to willing promoter entities.

For each good and service, there can be an identification of the reward (e.g., tokens, real cash, virtual cash, etc.) and the criteria for the award. Such criteria can include a minimum or range of unique promotions, the acceptable contexts for the promotions, and the acceptable third party recognitions (in terms of quantities and/or types). The context can include acceptable platforms and acceptable contexts (e.g., identifying positive and negative environments, etc.).

It can be appreciated that the databases can be structured to include much more data than that just discussed. The present disclosure provides examples, of how the rewarder entities and promoter entities can be matched up via the databases.

Machine Learning Tools for Content Analysis Engines

Content analysis engine technology and web crawlers are known, as well as machine learning generally. All can have good applicability as the content analysis engines 418 in accordance with the principles disclosed herein.

For example, virtual assistants such as Amazon.com, Inc.'s Amazon Alexa™ and Apple Inc.'s Siri™ use speech recognition to identify words, letters, and phrases spoken by a user.

Such virtual assistants utilize machine learning artificial intelligence algorithms to improve the speech recognition function. Similarly, Apple Inc.'s Shazam™ application, used to recognize songs and other sounds from snippets of sounds or sound recordings, uses machine learning to improve its recognition of music pieces. One provider that can provide speech and sound recognition for brands is Redflag Artificial Intelligence Inc. via their online platform at: http://www.redflagai.co.

Such programs or applications can be used to recognize spoken words including brand names or marks and sounds (e.g., jingles, recognizable musical works, or tag lines) associated with a good or service by processing such audible content posted on a platform, to thereby identify audible promotions of goods or services.

Text recognition can be accomplished by comparing word or letter patterns. As mentioned below, Google, Inc.'s Google Optical Character Recognition tool can be used to detect and extract text from images and the detected text can then be either translated into a digital format and compared against stored words or phrases, also in the digital format, or converted into a pattern that can be compared against stored patterns, much like image recognition.

Such programs or applications can be used to recognize written words including brand names or marks and tag lines associated with a good or service by processing such textual content posted on a platform, to thereby identify textual promotions of goods or services.

Image or visual recognition is somewhat more complicated, but employing machine learning can make it work well. There are some providers that can provide a visual search service such as Riviter, Inc. via their online platform at http://www.riviter.com. Such as service can be invoked and data ported from and to the service. A similar provider is Redflag Artificial Intelligence Inc. via their online platform at: http://www.redflagai.co.

Such programs or applications can be used to recognize images brand names or marks, tag lines associated with a good or service or images of goods by processing such image content posted on a platform, to thereby identify image promotions of goods or services.

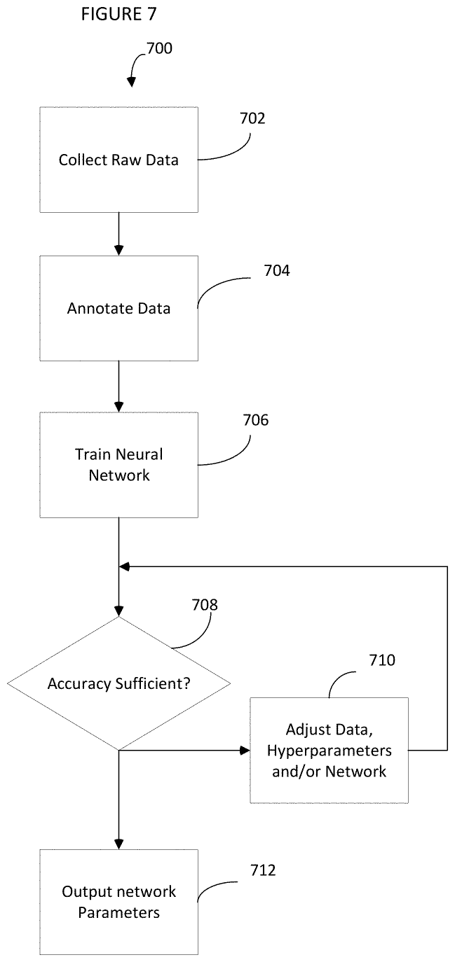

FIG. 7 depicts a flow chart 700 showing the process for training machine learning algorithms to create bespoke machine learning models for the content analysis engines. To start, raw data is collected in step 702. The raw data can be in various forms including photographs, renderings, hand or digital drawings, point cloud data or the like for visual content analysis engines; electronic text files or optical character recognized data for textual content analysis engines; and sound recordings for audible content analysis engines. The photographs can be obtained at eye level and/or using above head drones. Preferably, the raw data is image data relating to preselected goods. The photographs can be obtained through digital cameras, digital single-lens reflex (DSLR) cameras, cell phone cameras, drones, satellite imagery, point cloud data, scanned documents or other means. The point cloud data can be obtained through 3D laser scanning or other means. The raw data is electronically annotated in step 704 by assigning overall, object-, pixel- or point-level annotations depending on whether classification, object detection, segmentation or other machine learning techniques are to be used.

In step 706, the annotated data are used as inputs to train an existing neural network or other type of machine learning algorithm. References to neural networks in this disclosure include deep neural networks. Some common machine learning algorithms are Nearest Neighbor, Naïve Bayes, Decision Trees, Linear Regression, support Vector Machines, and Neural Networks. Such machine learning algorithms and how to train them, are well known although different vendors or suppliers may only support a subset of them. For example, Amazon Corporation's Amazon Machine Learning (Amazon ML) currently only supports three types of algorithms: binary classification, class classification, and regression. Google's open source TensorFlow machine learning framework was utilized to train open source neural networks or other types of machine learning algorithms in connection with the development of the present machine learning tool. Different machine learning frameworks may also be incorporated into this invention. Examples of the open source neural networks used are YOLO, Faster R-CNN, DeepLabV2, ResNet-101, PointNet and PointNet ++. These neural networks, described in the References section below, can be pre-trained on other datasets, such as the open source COCO dataset, prior to training on the data processed in step 704 to improve their accuracy. To reduce computation time, high-resolution files can be subdivided into multiple pieces, which are used as separate inputs for the neural network. The neural network outputs can then be recombined into the original format.

In step 708, the neural network's accuracy is evaluated by comparing the machine learning predictions to the annotated data. If the accuracy is insufficient, it can be improved in step 710 by increasing the quality (e.g. by using more consistent images, using better lighting conditions, using better focus, avoiding obstacles, etc.) and/or quantity of the input data, improving annotations (e.g. by making the annotations more precise, consistent, etc.), varying some or all of the network hyperparameters (e.g. epochs, iterations, batch size, learning rate, dropout, decay rate, etc.), and/or varying the network itself. If the accuracy is sufficient, the neural network parameters are output in step 712. The networks and outputted parameters are incorporated into content analysis engine as machine learning models for use in analyzing new, raw data. Over time, new data can be added to the original dataset and can be used to develop new machine learning models by retraining existing networks. The machine learning models can also be updated with new and improved neural networks as they are created. New machine learning techniques can also be incorporated into the content analysis engine as they are created.

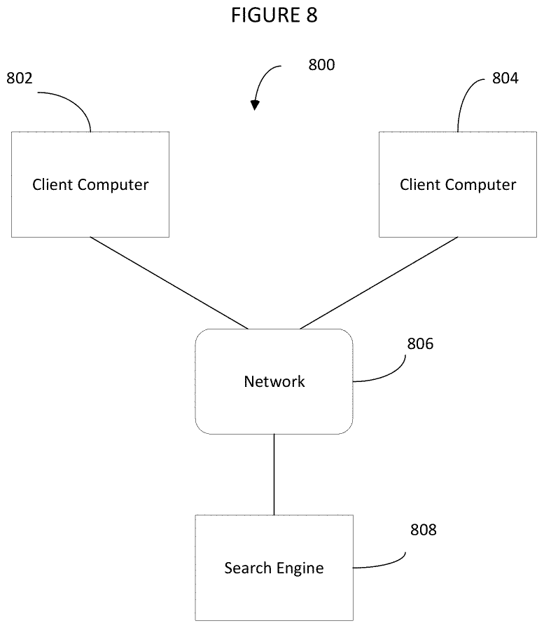

FIG. 8 depicts a block diagram showing a data processing system 800 comprised of a plurality of client computers 802 and 804 and a content analysis engine 808 connected via a network 806. The content analysis engine 808 may be a specially configured computer or computer system. The network 806 is of a type that is suitable for connecting the computers 802, 804, and 808 for communication, such as a circuit-switched network or a packet-switched network. Also, the network 806 may include a number of different networks, such as a local area network, a wide area network such as the Internet, telephone networks including telephone networks with dedicated communication links, connection-less network, and wireless networks. In the illustrative example shown in FIG. 2, the network 806 is the Internet. Each of the computers 802, 804, and 808 shown in FIG. 2 is connected to the network 806 via a suitable communication link, such as a dedicated communication line or a wireless communication link. Users can upload raw data to the machine learning tool 808, analyze the data as well as view and export the results through the network connection.

The following constitutes anon-exhaustive list of open-source, third-party resources that can be employed in the development of the machine learning tool for a content analysis engine:

You Only Look Once (YOLO): YOLO is a machine learning network the open source MIT license. This network can be used to train image-level classification models in the development of the presently disclosed machine learning tool. See, https://pjreddie.com/darknet/yolo/.

Tensorflow: Tensorflow is Google's open source framework for machine learning. Tensorflow is available under the Apache 2.0 open-source license. See, https://www.tensorflow.org.

Tensorflow Object Detection API: Tensorflow Object Detection API is an open source framework built on top of TensorFlow to construct, train and deploy object detection models. It can be used to train object detection models in the development of content analysis engine machine learning tool and is available under the Apache 2.0 license. See https://github.com/tensorflow/models/tree/master/research/object_detection.

Faster Region-Convolutional Neural Network (R-CNN): Faster R-CNN is a machine learning network that is available under the open source MIT license. This network, initialized with the pretrained weights from the MS COCO dataset, can be used to train object detection models in the development of a content analysis engine machine learning tool. See, https://github.com/ShaoqingRen/faster_rcnn and https://github.com/rbgirshick/py-faster-rcnn.

DeepLabV2: DeepLabV2 is a deep neural network for semantic segmentation that is available under the open source MIT license. This network can be used to train semantic segmentation models in machine learning tools. See, https://github.com/tensorflow/models/tree/master/research/deeplab.

ResNet101: ResNet101 is a residual neural network that is trained on more than a million images from the ImageNet database and is available under the open source MIT license. This network can used to train both the object detection and semantic segmentation machine learning models. See, https://github.com/KaimingHe/deep-residual-networks.

PointNet and PointNet ++: PointNet and PointNet ++ are neural networks for point cloud data that are available under the open source MIT license. These networks can be used to train machine learning models directly on point cloud data. See https://github.com/charlesq34/pointnet and https://github.com/charlesq34/pointnet2.

Common Objects in Context (COCO) dataset: The COCO dataset is a large-scale object detection, segmentation, and captioning dataset. This dataset can be used to initialize a neural network with the pre-trained weights. The COCO dataset is available under the Creative Commons Attribution 4.0 License. See, http://cocodataset.org.

Google's Optical Character Recognition (OCR): Google's OCR is a tool to detect text within images. Google's OCR is available under the Apache 2.0 open-source license. See https://cloud.google.com/vision/docs/ocr.

CloudCompare: CloudCompare is a software application for the processing of 3D point cloud and triangular mesh models, and can be employed to process a point cloud data and prepare it for machine learning analysis. CloudCompare is available under the GNU Library General Public License, version 2.0. See, cloudcompare.org.

Open Source Computer Vision Library (OpenCV): OpenCV is an open source computer vision and machine learning software library available under the Berkeley Software Distribution (BSD) license. See, opencv.org.

Pillow (PIL): Pillow is a PIL fork licensed under open source PIL Software License. It was developed by Alex Clark and contributors. See, https://pillow.readthedocs.io/en/stable.

Scikit-image: Scikit-image is an open-source image processing library for the Python programming language available under the Berkeley Software Distribution (BSD) license. See, https://scikit-image.org.

Python: Python is an open-source programming language available under the Python license. See, python.org.

NumPy: NumPy is an open-source Python package for scientific computing available under the NumPy license. See, www.numpy.org.

Note that the machine learning models can be updated with new and improved frameworks and neural networks as they are created. New machine learning techniques can also be incorporated as they are created. Therefore, additional open-source, third-party resources different than those listed above may be employed in the development of a content analysis engine with a machine learning tool.

Contextual Analysis

Recognition of the promotion of a good or service is a basic feature of a computer network based reward program management system in accordance with principles disclosed herein. It is also useful to be able to contextualize the promotion, i.e., identify the context in which a promotion is made. The context can be a determination of the promotion of the good or service is taking place in a preferred environment and the like. For example, it would not be preferred for the good or service to be promoted in a denigrating or deprecating way, or in an negative manner. This can be a qualitative judgment based on other identified features, such as utterances, text, or visual appearances in, adjacent to, or otherwise associated with the promotion. This can also be a quantitative judgment based on the number of followers of the promotion-containing post or number of signs of approval of the promotion-containing posts or number of re-posts of the promotion containing post (e.g., Facebook likes or Twitter re-tweets). These numbers can also be used to determine the value of a reward as discussed below.

The qualitative information can be discerned employing other machine learning tools used or by training a multi-faceted machine learning to recognize and interpret the utterances, text, or visual appearances in, adjacent to, or otherwise associated with the promotion. The quantitative information can also be recognized by a machine learning tool or extracting that information from a platform feed that separates out that information.

Archiving

When it comes to analysing a posting, particularly video, it is possible to archive it on the system for analysis. The option of archiving allows for a) maintaining the ability to analyse relatively ephemeral postings such as “stories” which only last a few hours and b) being able to present the post along with the rewards analysis to both the rewarder and the promoter.

To that end, user data and results of an award are recorded, along with a copy of the posting, in any format, thus making all of this available for easy summary and presentation. Generally, such user data, results, and posting also are stored in a relational database such as Mysql or Postgresql, and the relevant files stored on a file system.

The reward transaction can also be recorded using a cryptographic hash, and then stored on a blockchain with other metadata. All data pertaining to the transaction, including photos and video data can then be stored in a decentralised file system such as IPFS. See https://ipfs.io. Once the data is stored in IPFS, then a cryptographic hash link is generated. An example of such is: https://cloudflare-ipfs.com/ipfs/QmXoypizjW3WknFiJnKLwHCnL72vedxjQkDDP1mXWo6uco. If anything, even a single character, is changed, then the hash code changes which means the link is not valid.

Once the IPFS hash is created, it can then be written to a blockchain such as an Ethereum blockchain. The resulting token or “coin” can then be transferred into the online wallet on the system, belonging to the user. This means that whenever a user is enrolled on the system, as part of their user account, a blockchain wallet is created in order to take these coins, and then transfer them out.

Benefits of storing the transaction and post information in this manner include:

The record is immutable

The record is squarely in the hands of the promoter

A value can be assigned to it, so it acts both as the store of verified data+a store of value

The promoter can transfer it or delete it as they wish—which is critical to privacy

Since it is in the hands of the promoter then at all times, the system never actually holds that record.

Rewards

As mentioned above, the rewards to a promoter entity can take any or a combination of forms: kudos, acknowledgments, memberships (e.g., in a club), credits, real money, virtual money, goods, services, to name a few. The rewards can be rewarded based on criteria established by a rewarder entity. The rewards can be based on number of promotions, number of promotions within a preselected time period, the prominence of the promotion (e.g., size of the depiction or image of the good or length of time the promotion appears in a story or video). Further criteria can include the number of reposts including the promotion, the number of approvals of the promotion or the posting. For example, a basic reward level can be established for one set or band of criteria, and then an increase reward level can exist for any combination for exceeding the criteria or meeting increase criteria.

Also, the reward program management system can utilize smart contracts to immediately award a promoter entity when a rewardable promotion is identified. This would enable immediate per posting rewards simply for the post. A smart contract is a computer protocol intended to digitally facilitate, verify, or enforce the negotiation or performance of a contract. Smart contracts allow the performance of credible transactions without third parties. These transactions are trackable and irreversible. The parameters of a smart contract can be configured by the rewarder entity and can include the transfer of a store of value on the blockchain, such as a crypto currency like Bitcoin, to the promoter entity as soon as the terms of the smart contract have been met.

Yet further, rewards can be in the form of tokens on a blockchain. A rewarder entity could create their own type of blockchain token, then when promoter entities get points they could:
Get a portion of, or one token for each loyalty point they earn
Be required to generate a preselected number of loyalty points before getting a token

With blockchain tokens, it is necessary to have an electronic wallet address to have the tokens transferred. As long as a promoter entity does not enroll a wallet address, the reward program management system can “allocate” the token, or part thereof, to them, but it will be custodized in the wallet of whomever (e.g., a rewarder entity, or the management system) is providing the token. Once the promoter entity provides their electronic wallet address, then transfers of the tokens can take place.

In conjunction with the issuance of a reward, the system may inform the promoter entity as to the issuance of the reward via a communication using, e.g., a message system native to the reward program management system or an external system such as, e.g., email, a social platform messaging system, a cellular text message, etc. The communication can be made on behalf of the reward program system or the rewarder entity.

As can be appreciated, a product manufacturer could use this technology to see how many people are posting about a product, e.g., posting photographs with the product and/or how many times the product appears in a particular post. Conversely, this technology allows one to analyze profiles of people using or posting photographs with products from a competitor.

The search technology is, of course, not limited to social media posts. At a higher, broader level, it can be used in connection with any content sent to the content analysis engine, or which the content analysis engine can access, including, any web site or online platform, or content forwarded to the server.

Methods of Rewarding Promoter Entities

There can be many aspects to methods implementing or utilizing a reward program management system in accordance with principles disclosed herein. There are the processes via which the promoter entities and rewarder entities are enrolled, the process via which the promoter entities are rewarded, and the processes via which promotions are analysed and recognized as rewardable.

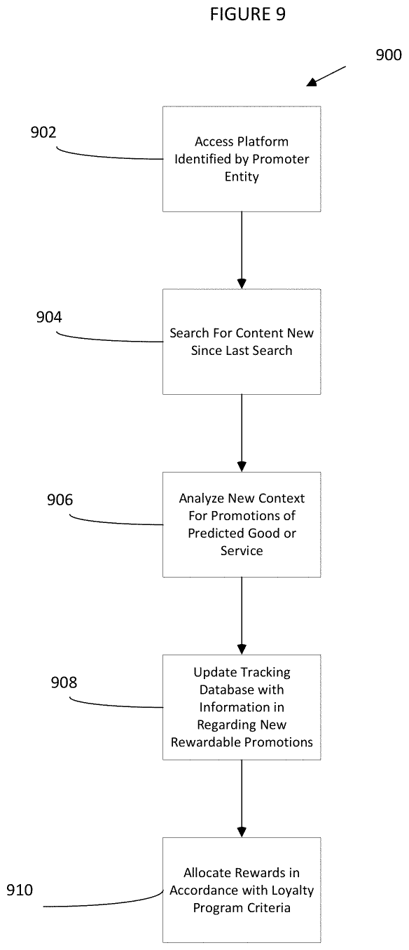

However, referring to FIG. 9, a method 900 for managing a computer network-based reward program for enrolled promoters is depicted in the form of a flow chart. As illustrated, once a rewarder entity has enrolled a good or service or rewarding by the reward program system and a promoter entity is enrolled in a reward program associated with the good or service, the method 900 includes a step 902 in which a computer network-based based loyalty management system (e.g., system 400) automatically accesses a platform on the network per identification information in a promoter entities profile or records in the system. This is accomplished by the continuously executing promotion tracking module 426 identifying the enrolments and determining to search, on a preselected interval basis, the platforms identified by the promoter entity. Assuming the access effort of a platform was successful, the system then automatically searches for content posted by the promoter entity which is new since a last time the platform was accessed by the system. This is accomplished, e.g., by the promotion tracking module automatically invoking one or more content analysis engines 418 to review any new postings, or invoking the Content analysis engine Interface 420, which in turn can invoke third party content analysis engines that are external to the system 400. Assuming new content is located, in a step 906, the new content automatically is analyzed to identify rewardable promotions of preselected goods or services for which the promoter entity has enrolled. This analysis may include using artificial intelligence tools to identify a promotion as well the context of the promotion in terms of recognitions by others and acceptable environments, conditions, and so on, as discussed above. Rewardability can be determined on any criteria established for the system, usually by a rewarder entity.

Assuming a rewardable promotion is identified, in step 908 the system automatically updates the tracking data associated with the promoter entity so that a record is maintained of the promotion. Then, in step 910, the system automatically allocates the agreed upon reward to the promoter entity. This is done by the Rewards Tracking module 428 as it either executes on its own schedule or is invoked by the Reward Tracking module in view of the identification of a rewardable promotion. As mentioned above, the reward might be in the form of a credit, real money, virtual money, or a blockchain token that requires the promoter entity to further interact with the system to effect transfer of the rewards to, e.g., an electronic wallet.

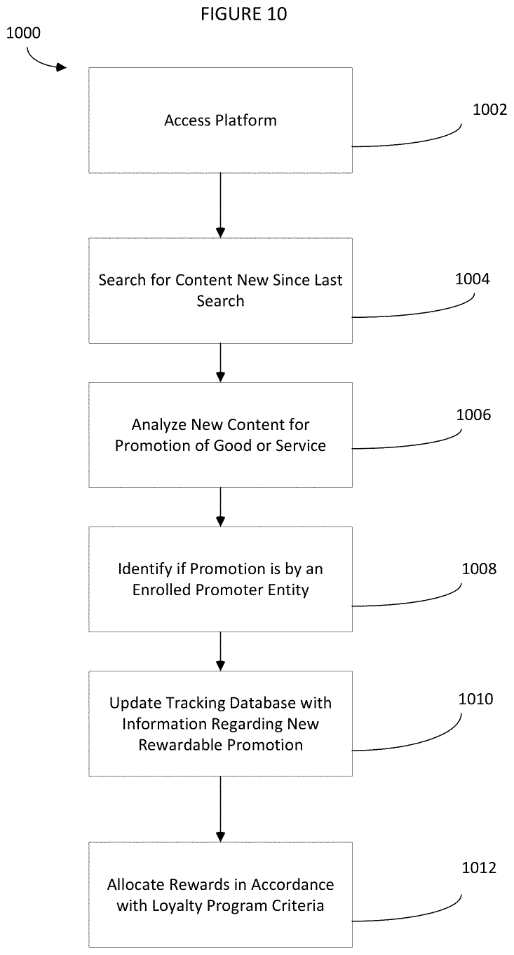

In FIG. 10, a similar method 1000 is depicted in the form of a flow chart. However, in this method, the system 400 automatically searches out promotions on selected platforms and then later identifies if the promotion is by an enrolled promoter entity. In step, 1002, the system accesses a platform on the network as described above. Assuming access is successful, the system will automatically search the platform as a whole, to the extent permitted by the platform and its users, for new content posted since a last search by invoking the Rewards Tracking module 426. Assuming new content is located, in step 1006 the system automatically analyzes the new content for rewardable promotions of preselected goods or services by automatically invoking the one or more content analysis engines 418 or the Content analysis engine interface 420, as described above. Artificial intelligence machine learning tools can be invoked by the content analysis engines for this purpose, as described above. Assuming a rewardable promotion is identified, the system automatically determines if the promotion is by an enrolled promoter entity, again via the Reward Tracking module 426. Assuming that the promotion is by an enrolled promoter entity, in step 1010 the tracking database data associated with the enrolled promoter entity automatically is updated to record the promotion by the Reward Tracking module, as described above. Then, in step 1012, the system automatically awards the promoter entity with the agreed upon rewards by execution of the Rewards Tracking module 430 either at preselected intervals or by being invoked by the Rewards Tracking module 428.

In either of these methods, or in any other method employing principles disclosed herein, the tracking database can include storage of any information gleaned from a search, including the information mentioned above in connection with the database information of FIG. 5.

In an embodiment, the method includes detecting a hashtag in the social media post, associated with the good or service. In broad terms, a hashtag is a type of metadata tag used on social networks, which allows users to apply dynamic, user-generated tagging which makes it possible for others, in this case the content analysis engine, to easily find messages with a specific theme or content.

It can be appreciated that the coding for implementing the foregoing is stored in anon-transitory storage medium so that it can be retrieved or read and executed by one or more processing units.

The present invention thus provides a powerful way of enhancing and rewarding customer loyalty. It also provides useful information regarding users and the context/surroundings in which they work and live.

The terminology used herein is for describing particular exemplary embodiments and is not intended to be necessarily limiting of this disclosure. As used herein, the singular forms “a,” “an” and “the” are intended to include the plural forms as well, unless the context clearly indicates otherwise. Also, as used herein, the term “a” and/or “an” shall mean “one or more,” even though the phrase “one or more” is also used herein. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof. Furthermore, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

This detailed description has been presented for various purposes of illustration and description, but is not intended to be fully exhaustive and/or limited to this disclosure in various forms disclosed. Many modifications and variations in techniques and structures will be apparent to skilled artisans, without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

What is claimed is:

1. A non-transitory storage medium having computer processor executable instructions that when executed by one or more computer processors, cause the one or more computer processors to:
enroll a rewarder entity with information about a preselected good or service;
permit the rewarder entity to establish rules for rewarding promotions of the preselected good or service;
enroll a promoter entity in a reward program by associating the promoter entity with one or more computer network platforms;
automatically search at least one of the one or more computer network platforms for an image or audio promotion of the preselected good or service;
using a trained machine learning tool, automatically recognize a rewardable promotion of the preselected good or service by the promoter entity on the at least one of the one or more computer network platforms and generate an output characterizing the recognized rewardable promotion of the preselected good or service, the trained machine learning tool trained to recognize promotions of the preselected good or service on the one or more computer network platforms based on image or audible data in which the preselected good or service can be identified;
automatically award the promoter entity a predetermined reward for the rewardable promotion of the preselected good or service based on the output of the trained machine learning tool and the rules for rewarding promotions of the preselected good or service; and
automatically communicate the awarding of the reward to the promoter entity, the rewarder entity, or both.

2. The storage medium of claim 1, wherein automatically recognizing a rewardable promotion includes comparing characterization data of the promotion against predetermined criteria establishing parameters for when a promotion can be deemed rewardable.

3. The storage medium of claim 1, wherein the loyalty reward includes an item of value selected from the group consisting of an acknowledgement, a membership, a credit, real money, virtual money, a blockchain token, a good, and a service.

4. The storage medium of claim 1, wherein the instructions, when executed by one or more computer processors, cause the one or more computer processors to:
recognize a context in which the promotion of the good or service is made; and
associate a qualitative judgment with the promotion of the good or service.

5. The storage medium of claim 1, wherein the instructions, when executed by one or more computer processors, cause the one or more computer processors to:
recognize a context in which the promotion of the good or service is made; and
associate a quantitative assessment with the promotion of the good or service.

6. The storage medium of claim 1, wherein automatically recognizing a rewardable promotion of the preselected good or service by the promoter entity comprising automatically invoking a content analysis engine.

7. The storage medium of claim 6, wherein the content analysis engine automatically invokes the trained machine learning tool.

8. The storage medium of claim 1, wherein the at least one of the computer network-based platforms is a social media platform.

9. The storage medium of claim 1, wherein the instructions, when executed by one or more computer processors, cause the one or more computer processors to enroll a rewarder entity by receiving rewarder entity data that associates a rewarder entity with the preselected good or service and the criteria.

10. A system comprising:
one or more data processors connected to a computer network;
computer processor readable memory in communication with the one or more processors; and
stored in the memory, code including data processor executable instructions, the code including:
a promoter entity enrolment module which can (a) receive promoter entity data identifying the promoter entity and (b) associate the promoter entity with one or more computer network platforms;
a rewarder entity enrolment module which can receive rewarder entity data identifying the rewarder entity, a good or service, and reward program information with criteria for rewarding promotion of the good or service;
a content analysis engine which can search a posting on the one or more platforms and generate a search result;
a promotions tracking module which automatically invokes the content analysis engine and analyze the search result to identify a rewardable promotion;
one or more databases storing the promoter entity data and the rewarder entity data; and
processor executable instructions that when executed by one or more computer processors, cause the one or more computer processors to:
enroll a rewarder entity with information about a preselected good or service;
permit the rewarder entity to establish rules for rewarding promotions of the preselected good or service;
enroll a promoter entity in a reward program using the promoter entity enrolment module and associating the promoter entity with at least one of the one or more computer network platforms;
automatically search the one or more computer network platforms for image or audio promotion of the preselected good or service using the content analysis module;
using a trained machine learning tool, automatically recognize a rewardable promotion of the preselected good or service by the promoter entity on at least one of the one or more computer network platforms and generate an output characterizing the recognized rewardable promotion of the preselected good or service, the trained machine learning tool trained to recognize promotions of the preselected good or service the one or more computer network platforms based on image or audible data in which the preselected good or service can be identified;
automatically award the promoter entity a predetermined reward for the rewardable promotion of the preselected good or service based on the output of the trained machine learning tool using the promotions tracking module and the rules for rewarding promotions of the preselected good or service; and
automatically communicate the awarding of the reward to the promoter entity, the rewarder entity, or both.

11. The system of claim 10, wherein the code includes a rewards tracking module via which the rewarder entity can review the each promotion by the promoter entity.

12. The system of claim 10, wherein the content analysis engine automatically invokes the trained machine learning tool.

13. The system of claim 12, wherein the machine learning tool is effective to generate a qualitative characterization of a context in which the promotion is recognized.

14. The system of claim 12, wherein the machine learning tool is effective to generate a quantitative characterization of a context in which the promotion is recognized.

15. The system of claim 10, where the platforms included social media platforms, content sharing platforms, video conferencing platforms, gaming and esports platforms, podcast platforms, or any combination of the foregoing.

16. The system of claim 10, wherein the code further comprises a promoter entity interface via which the promotor entity can enroll in the reward program system.

17. The system of claim 10, wherein the code further comprises a rewarder entity interface via which the rewarder entity can enroll in the reward program system.

18. The system of claim 10, where the code establishes automatic invocation of the content analysis engine by the promotions tracking module.

19. A method of managing a reward program comprising executing processor executable computer instructions on a server connected to a computer network and:
enrolling a rewarder entity with information about a preselected good or service;
permitting the rewarder entity to establish rules for rewarding promotions of the preselected good or service;
enrolling a promoter entity in a reward program system by associating the promoter entity with one or more computer network platforms and a predetermined good or service;
automatically invoking a content analysis engine and searching the one or more platforms for image or audible promotion of the preselected good or service;
using a trained machine learning tool, automatically recognizing a rewardable promotion of the preselected good or service by the promoter entity on at least one of the one or more computer network platforms and generating an output characterizing the recognized rewardable promotion of the preselected good or service, the trained machine learning tool trained to recognize promotions of the preselected good or service on the one or more computer network platforms based on image or audible data in which the preselected good or service can be identified;
automatically rewarding the promoter entity with a predetermined reward for the rewardable promotion of the preselected good or service based on the output of the trained machine learning tool and the rules for rewarding promotions of the preselected good or service; and
automatically communicate the awarding of the reward to the promoter entity, the rewarder entity, or both.

20. The method of claim 19, wherein using the machine learning tool to provide a qualitative characterization of a context in which the good or service is promoted.

21. The method of claim 19, wherein the recognizing includes identifying and storing data characterizing the promotion.

22. The method of claim 19, wherein the rewarding includes allocating the reward in accordance with predetermined criteria and data characterizing the recognized promotion.

23. The method of claim 19 comprising enrolling a rewarder entity by associating the rewarder entity with the preselected good or service and criteria for awarding the reward.

24. The method of claim 19, wherein the enrolling of the promoter entity comprises serving a promoter entity enrolment interface with interactive webpages via which the promoter entity can enter promoter entity data including the one or more computer network-based platform accounts.

25. The method of claim 23, wherein the enrolling of a rewarder entity comprises serving a rewarder entity enrolment interface with interactive webpages via which the rewarder entity can enter rewarder entity data identifying the rewarder entity and the preselected good or service and the criteria for awarding the reward.

26. The method of claim 19 wherein the network-based platforms are social media platforms, content sharing platforms, video conferencing platforms, gaming and esports platforms, podcast platforms.

27. The method of claim 20, further comprising using the machine learning tool to provide a qualitative characterization of a context in which the good or service is promoted.
